(19) United States
(12) Patent Application Publication
(10) Pub. No.: US 2006/0021708 A1
(43) Pub. Date: Feb. 2, 2006

(54) Tape cutting mechanism

(75) Inventor: Robert Kops, Bayshore, NY (US)

Correspondence Address: KEUSEY, TUTUNJIAN & BITETTO, P.C., 14 VANDERVENTER AVENUE, SUITE 128, PORT WASHINGTON, NY, 11050, US

(73) Assignee: EZ-TEK INDUSTRIES, INC.

(21) Appl. No.: 11/184,139

(22) Filed: Jul. 19, 2005

Related U.S. Application Data
(60) Provisional application No. 60/598,103, filed on Aug. 2, 2004.

(51) Int. Cl. B32B 37/00; B32B 38/04

(52) U.S. Cl. 156/510

(57) ABSTRACT

A cutting mechanism includes a tensioned tape and a cutting assembly. The cutting assembly includes an edge for cutting tape. The tape is drawn over the edge to cause a rotation such that when a given rotation has been achieved contact forces between the tape and the edge cause the tape to be severed cleanly. The tape is preferably a filament tape. An apparatus for severing tape includes a taping device which contacts an object and applies tape to the object as the object moves relative to the taping device. A cutting assembly has a cutting edge disposed at an angle relative to a direction of motion of the object such that as the object passes the cutting assembly the cutting edge engages the tape and rotates to a position which severs the tape.

### RELATED APPLICATION DATA

This application claims priority to Provisional Application Ser. No. 60/598,103, filed on Aug. 2, 2004, which is incorporated by reference herein.

### BACKGROUND

1. Technical Field

This disclosure relates to product packaging devices, and more particularly, to a tape cutting mechanism suitable for cutting filament tape.

2. Description of the Related Art

One important aspect of manufacturing products includes the packaging in which the product is shipped and presented for sale. The packaging in which a product is placed needs to be secure enough to prevent unwanted tampering of the product. In addition, packaging is functional as well. For example, in many applications the packaging provides protection during shipping and during display of the items in, for example, a store.

One important type of packaging includes employing non-corrugated or corrugated boxes. These boxes are often filled with materials and then taped shut. Taping may be performed by hand or be performed by employing an automated mechanism. Tape may include clear tapes, metalized tapes or filament tapes.

Filament tapes include filaments, which increase the tensile strength of the tape. These tapes are often very difficult to cut and require a substantial amount of shear force to sever the tape. Large shear forces may be implemented using a transverse cutter such as a scissor. However, this is disadvantageous in packaging lines where the tape is applied to boxes or other packaging in the axial direction (e.g., the direction of motion of the box).

Therefore, a need exists for a cutting mechanism for filament or other high strength tapes, especially while the package is in motion (“on the fly”).

### SUMMARY OF THE INVENTION

A cutting mechanism includes a tensioned tape and a cutting assembly. The cutting assembly includes an edge for cutting tape. The tape is drawn over the edge to cause a rotation such that when a given rotation has been achieved contact forces between the tape and the edge cause the tape to be severed cleanly. The tape is preferably a filament tape. Advantageously, the present invention provides a simple mechanical solution to a longstanding problem for cutting filament tapes without stopping the package that is being taped on the conveyor line.

A cutting mechanism includes a tensioned tape and a cutting assembly. The cutting assembly includes an edge for cutting tape. The tape is drawn over the edge to cause a rotation such that when a given rotation has been achieved contact forces between the tape and the edge cause the tape to be severed cleanly. The tape is preferably a filament tape. An apparatus for severing tape includes a taping device which contacts an object and applies tape to the object as the object moves relative to the taping device. A cutting assembly has a cutting edge disposed at an angle relative to a direction of motion of the object such that as the object passes the cutting assembly the cutting edge engages the tape and rotates to a position which severs the tape.

In another embodiment, an apparatus for severing tape includes a conveyor surface which supports an object moving in a first direction and a taping device including a tape dispensing roller which contacts the object and applies tape to the object as the object moves relative to the taping device. A cutting assembly has a cutting edge disposed at an angle relative to a direction of motion of the object, the cutting edge rotatably connects to a fixed position relative to the conveyor surface such that as the object passes the cutting assembly the cutting edge engages the tape and rotates to a position which severs the tape.

Other embodiments include the cutting assembly may be rotatably biased to engage the tape. The taping device may include a roller, which contacts the object to apply the tape thereto. The taping device may include a roller arm which supports the roller, the roller arm including a camming portion which secures the tape to the object. The tape may include a filament tape. The conveyor surface may include a conveyor device which supports the object and permits motion of the object in the direction of motion. The cutting edge may be disposed a distance below the conveyor surface before engaging the tape. This distance may be about ¼ inches below the surface where the object is supported by the conveyor surface.

These and other objects, features and advantages of the present invention will become apparent from the following detailed description of illustrative embodiments thereof, which is to be read in connection with the accompanying drawings.

### BRIEF DESCRIPTION OF DRAWINGS

This disclosure will present in detail the following description of preferred embodiments with reference to the following figures wherein:

FIG. 1 is a side view of a cutting mechanism showing a first position of a knife assembly and a taping assembly in accordance with one embodiment of the present invention;

FIG. 2 is a side view of the cutting mechanism of FIG. 1 showing a cutting position of the knife assembly and the taping assembly in accordance with one embodiment of the present invention;

FIG. 3 is a magnified view of a cutting edge at a point of engagement with a tape in accordance with one embodiment of the present invention;

FIG. 4 is a magnified view of a cutting edge at a point of cutting the tape in accordance with one embodiment of the present invention; and

FIG. 5 is a diagram showing alternate motion for rotation of a cutting edge in accordance with embodiments of the present invention.

### DETAILED DESCRIPTION OF PREFERRED EMBODIMENTS

The present invention provides a cutting mechanism, which works in conjunction with a conveyor belt or other moving line to cut tape applied to a package or box on the line while the box or package is still moving. The present invention is particularly useful for cutting high strength tapes although all tapes or flexible bands may employ the present invention. In addition, preferred embodiments are particularly suited for automatic tape dispensing mechanisms.

The present invention will now be described in terms of a cutting mechanism working in conjunction with a machine or frame which permits boxes to be conveyed thereon. The cutting mechanism employs a sharp surface or edge that is contacted by a length of tape. The tape causes the edge to rotate with the tape until an appropriate angle is achieved. The appropriate angle causes sufficient stress in the tape to cause the tape to yield under the shear force imparted thereto.

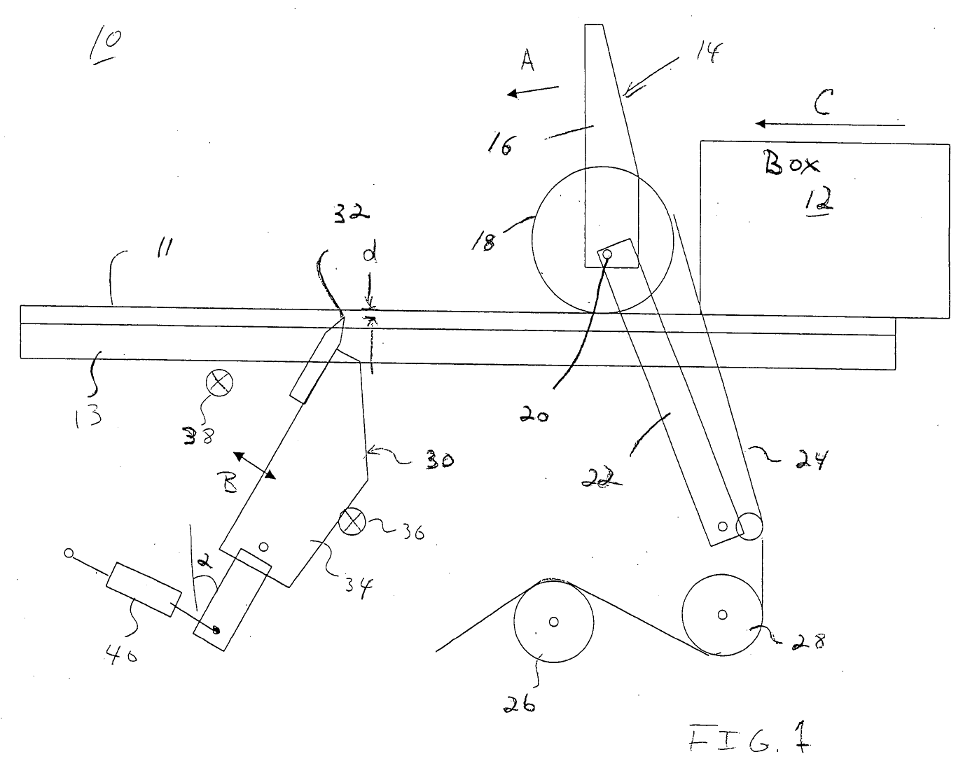

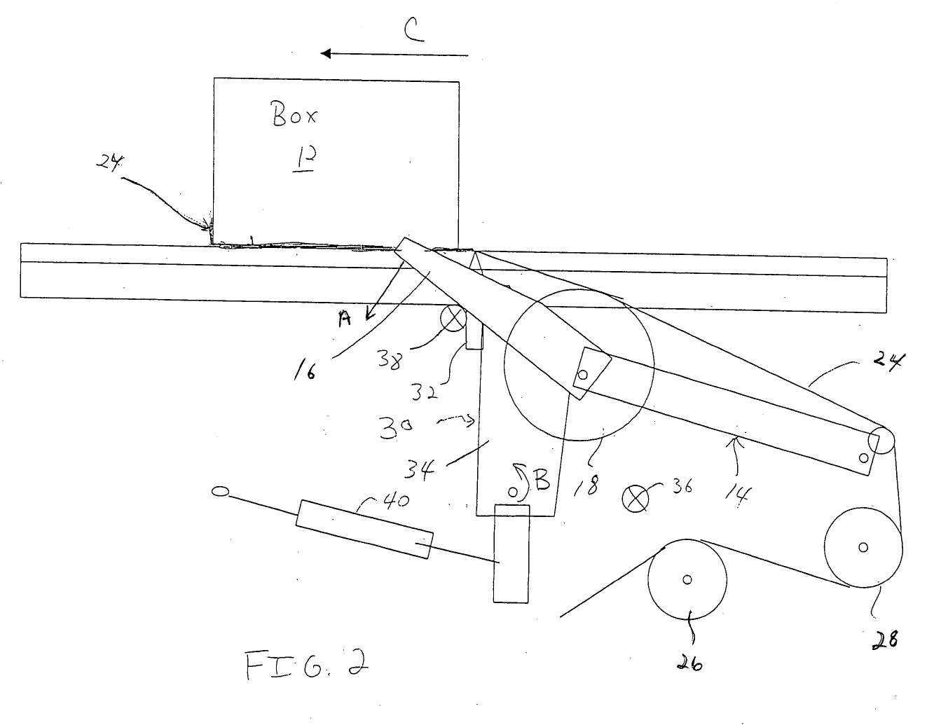

It is to be understood that the apparatus depicted in FIGS. 1 and 2 may be disposed between two rails or conveyors and disposed centrally relative to the boxes or objects conveyed over the apparatus. The apparatus may also be offset from a central position between the rails or conveyors or disposed next to a single conveyor. It is also to be understood that the apparatus, though depicted below the object or box, may be above the object or on the side of the object or box to permit taping on any position of the box or object.

Referring now in specific detail to the drawings in which like reference numerals identify similar or identical elements throughout the several views, and initially to FIG. 1, a side view of a box taping machine 10 is illustratively shown in accordance with one embodiment of the present invention. A box or other package 12 to be taped is placed on a conveyer 13. Conveyer 13 may be active or passive, but imparts or sustains a motion of box 12 in the direction of arrow “C”. Passive conveyers 13 may include a ball bearing, wheeled, rollered or other low friction surface 11 with or without an incline (the incline for employing gravity as a motion force). An active conveyer 13 may include a belt 11 or other driven mechanism.

A pivoted taping device 14 includes a roller 18 and a roller arm 22. Roller arm 22 includes a camming portion 16, which is employed to rotate with the motion of box 12 and provide a force to secure tape 24 against the underside of the box 12 during taping operations. Roller arm 22 is biased in the upward position shown in FIG. 1.

Tape 24 may include any type of tape, but the present invention is particularly useful when tape 24 includes a high strength material or is supported by longitudinal filaments to add tensile strength. Tape 24 is dispensed from roller 18 and follows a path, which may include tensioners 26 and 28. Other dispensing paths for tape 24 are also contemplated.

When box 12 contacts roller 18, tape 24 is applied to a portion of the box 12, and roller 18 continues to follow the surface of the underside of the box 12. As box 12 continues to move in the direction of arrow “C”, device 14 begins to rotate in the direction of arrow “A”. Tape 24 is rolled onto the bottom surface of box 12 to seal flaps or otherwise secure tape to the surface of box 12. It is noted that tape 24 may be applied to a leading comer, a following comer or the entire underside of box 12 by adjusting the spacings and stops for the respective hardware used in applying the tape 24.

As box 12 travels in the direction of arrow “C”, box 12 passes over a cutting assembly 30. Cutting assembly 30 includes a cutting edge 32, which remains at an acute angle a with the vertical in its rest position. Angle α preferably includes an angle of 45 degrees or less, more preferably about 30-45 degrees. The angle α is maintained at rest by employing a biasing device 40, such as a spring, and a front stop 38 and a rear stop 36 to limit the range of motion of assembly 30 and therefore edge 32.

Advantageously, edge 32 remains below the box 12 to ensure that no contact occurs between box 12 and edge 32. In one embodiment, a dimension “d” is about ¼ inches. Other dimensions may also be employed; however, it has determined that this ¼ inch dimension provides good results for filament tapes.

Referring to FIG. 2, as the box 12 passes assembly 30, taping device 14 is rotated fully such that knife edge 32 engages tape 24. Further motion of box 12 in the direction of arrow “C” causes tape 24 to become taught over edge 32, and then begins to rotate a knife arm 34, which secures edge 32. Knife arm 34 rotates in the direction of arrow “B” in conjunction with the tape 24 until knife arm 34 is substantially vertical (e.g., engages stop 38). When the edge 32 is in its fully rotated (substantially vertical) position, tape 24 is severed cleanly due to the normal stress in tape 24 and the edge 32 shear force. This is performed without stopping box 12 as it travels along conveyer 13. Both the weight of the box or object 12 and the motion of the box or object 12 contribute to forces used to sever the tape 24.

After tape 24 is severed, camming device 16 continues to engage tape 24 and continues to compress tape 24 to the surface of box 12. Once the box 12 passes the end of camming device 16, device 14 returns to its position as shown in FIG. 1, as does assembly 30. Edge 32 may include steel, titanium or other durable material capable of maintaining a sharp edge. Edge 32 preferably extends across the entire width of tape 24, but may be less than the entire width of the tape. Edge 32 may also include an inclined edge being higher on one side than the other to promote cutting from one side of the tape to the other. In other words, the tape engages the higher side of the inclined edge 32 first and gradually contacts engages the tape across the edge as cutting progresses.

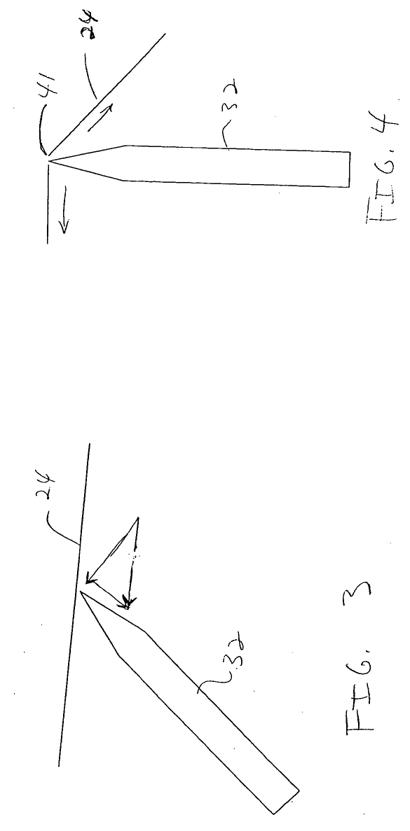

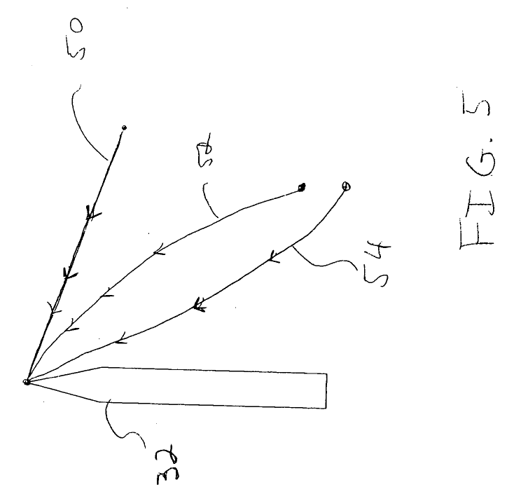

Referring to FIG. 3, a magnified view of edge 32 is shown at the point of engagement with tape 24. Engagement occurs as a result of the downward rotation of device 14 (FIG. 2) in the direction of arrow “A”. After engagement, tape 24 is drawn in the direction of arrow “E”, which imparts a resultant force, which can be broken down into component forces. An axial component force acts down edge 24 and a perpendicular component, which acts perpendicular to edge 32. The axial component provides friction while the perpendicular component causes rotation of assembly 30. Assembly 30 is then rotated to the position shown in FIG. 4 and rotation is halted by stop 38.

Referring to FIG. 4, once rotation is halted for assembly 30, tape 24 continues to be pulled by box 12 (FIG. 2) and tensioned by tensioners 26 and 28. This results in two portions of tape being pulled apart on opposite sides of edge 32 and being pulled down upon the cutting point of edge 32. As a result, tape 24 is severed cleanly.

Referring to FIG. 5, rotation of cutting assembly 30 may include different motions as an alternative to plain rotation. For example, a cam mechanism or a peg in a race may create different motions for cutting edge 32. Some examples may include a linear motion 50, an asymmetric arc 52, an exponential profile 54 or other profiles. In addition, motion of assembly may be controlled by mechanical manipulation as a result of tape motion or may be controlled by an electronic device including sensors and servo motors or actuators or the like to provide a desired motion for the best cutting for the application.

The present invention may be employed on other media instead of or in addition to tape. For example, video or audio tapes, belts or other flexible longitudinal materials may benefit from the present invention. Also combinations of elements may be employed in this and other applications within the spirit and scope of the invention.

Having described preferred embodiments for a tape cutting mechanism (which are intended to be illustrative and not limiting), it is noted that modifications and variations can be made by persons skilled in the art in light of the above teachings. It is therefore to be understood that changes may be made in the particular embodiments of the invention disclosed which are within the scope and spirit of the invention as set forth in the appended claims.

What is claimed is:

1. An apparatus for severing tape, comprising:
a taping device which contacts an object and applies tape to the object as the object moves relative to the taping device; and
a cutting assembly having a cutting edge disposed at an angle relative to a direction of motion of the object such that as the object passes the cutting assembly the cutting edge engages the tape and rotates to a position which severs the tape.

2. The apparatus as recited in claim 1, wherein the cutting assembly is rotatably biased to engage the tape and upon engagement with the tape rotates with the tape to impart a shear force to the tape.

3. The apparatus as recited in claim 1, wherein the taping device includes a roller, which contacts the object to apply the tape thereto.

4. The apparatus as recited in claim 3, wherein the taping device includes a roller arm which supports the roller, the roller arm including a camming portion which secures the tape to the object.

5. The apparatus as recited in claim 1, wherein the tape includes a filament tape.

6. The apparatus as recited in claim 1, further comprising a conveyor surface which supports the object, and the cutting edge being disposed a distance below the conveyor surface before engaging the tape.

7. The apparatus as recited in claim 1, wherein the taping device includes a roller, which contacts the object to secure the tape to the object.

8. The apparatus as recited in claim 1, further comprising a stop which stops rotation of the cutting device at a position likely to sever the tape.

9. An apparatus for severing tape, comprising:
a conveyor surface which supports an object moving in a first direction;
a taping device including a tape dispensing roller which contacts the object and applies tape to the object as the object moves relative to the taping device;
a cutting assembly having a cutting edge disposed at an angle relative to a direction of motion of the object, the cutting edge rotatably connected to a fixed position relative to the conveyor surface such that as the object passes the cutting assembly the cutting edge engages the tape and rotates to a position which severs the tape.

10. The apparatus as recited in claim 9, wherein the cutting assembly is rotatably biased to engage the tape.

11. The apparatus as recited in claim 9, wherein the taping device includes a roller, which contacts the object to apply the tape thereto.

12. The apparatus as recited in claim 11, wherein the taping device includes a roller arm which supports the roller, the roller arm including a camming portion which secures the tape to the object.

13. The apparatus as recited in claim 9, wherein the tape includes a filament tape.

14. The apparatus as recited in claim 9, wherein the conveyor surface includes a conveyor device which supports the object and permits motion of the object in the direction of motion.

15. The apparatus as recited in claim 9, wherein the cutting edge is disposed a distance below the conveyor surface before engaging the tape.

16. The apparatus as recited in claim 15, wherein the distance is about ¼ inches.

17. An apparatus for severing tape, comprising:
a conveyor device which supports an object moving in a first direction;
a taping device pivotally connected to the conveyor device and rotatably biased to engage the object, the taping device including a roller arm having a tape dispensing roller supported thereby which contacts the object and applies tape to the object as the object moves relative to the taping device, the roller arm further comprising a camming portion which follows the roller and further secures the stapes to the object; and
a cutting assembly having a cutting edge disposed in a first position at an angle relative to a direction of motion of the object, the cutting assembly rotatably connected to the conveyor device and biased toward engagement of the tape such that as the object passes the cutting assembly the cutting edge engages the tape and rotates to a stop position which severs the tape.

18. The apparatus as recited in claim 17, wherein the tape includes a filament tape.

19. The apparatus as recited in claim 9, wherein the cutting edge is disposed a distance below the conveyor surface before engaging the tape.

20. The apparatus as recited in claim 19, wherein the distance is about ¼ inches.
